(19) United States
(12) Patent Application Publication
(10) Pub. No.: US 2026/0156402 A1
(43) Pub. Date: Jun. 4, 2026

(54) EARPHONE WITH WEARING STABILITY

(71) Applicant: Shenzhen Baseus Technology Co., Ltd., Shenzhen (CN)

(72) Inventors: SHI-YOU HE, Shenzhen (CN); Yangwen Jiang, Shenzhen (CN); Tian-Tian Li, Shenzhen (CN); Tao Chen, Shenzhen (CN)

(21) Appl. No.: 19/454,703

(22) Filed: Jan. 21, 2026

Related U.S. Application Data
(63) Continuation of application No. PCT/CN2023/130178, filed on Nov. 7, 2023.

(30) Foreign Application Priority Data
Aug. 8, 2023 (CN) 202322122564.X
Aug. 8, 2023 (CN) 202322143333.7

(51) Int. Cl. H04R 1/10; H04R 1/1025

(52) U.S. Cl. CPC H04R 1/105; H04R 1/1025; H04R 1/1066

(57) ABSTRACT

The present embodiment provides an earphone with wearing stability, which includes a fitting portion and a connection portion. The fitting portion includes a sound outlet. The connection portion is connected to the fitting portion and extends along a curved direction. A connection position between the connection portion and the fitting portion is located at a first side of a longitudinal center plane of the fitting portion. A connection surface of the connection position is inclined towards skin of a user skin when the earphone is worn on an ear of the user. The longitudinal center plane contains a geometric center point of the fitting portion and has a normal line parallel to a thickness direction of the fitting portion. The first side is a side configured to be in contact with the skin when the earphone is worn on the ear.

### CROSS-REFERENCE TO RELATED APPLICATION

This application claims all benefits accruing under 35 U.S.C. § 119 from China Patent Application No. 202322122564.X, filed on Aug. 8, 2023, and China Patent Application No. 202322143333.7, filed on Aug. 8, 2023, in the China National Intellectual Property Administration, the content of which is hereby incorporated by reference. This application is a continuation of international patent application PCT/CN2023/130178 filed Nov. 7, 2023, and the content of which is hereby fully incorporated by reference.

### TECHNICAL FIELD

The present disclosure relates to the technical field of sound generation devices, and more particularly, to an earphone with wearing stability.

### BACKGROUND

Earphones are a pair of transducers, which receive electrical signals from a media player or a receiver and convert the electrical signals into audible sound waves through speakers placed near the ears. The earphones are widely used in people's daily life, and may be classified into semi-open-back earphones, open-back earphones, and closed-back earphones based on the structure of the earphones. The earphones may also be classified into over-ear earphones, on-ear earphones, and in-ear earphones based on how a user wears the earphone.

In related arts, the open-back earphones cannot closely be attached to the user's ears. Also, such earphones are hung on the ears only by curved shape of connection portions of the earphones, resulting in wearing discomfort. Furthermore, during movement, the earphones may easily be separated from the ears due to poor stability, which leads to a poor user experience.

Therefore, there is a room for improvements in the arts.

### SUMMARY

The present embodiment provides an earphone with wearing stability, which includes a fitting portion and a connection portion. The fitting portion includes a sound outlet. The connection portion is connected to the fitting portion and extends along a curved direction. A connection position between the connection portion and the fitting portion is located at a first side of a longitudinal center plane of the fitting portion. A connection surface of the connection position is inclined towards skin of a user skin when the earphone is worn on an ear of the user. The longitudinal center plane cis a plane where a geometric center point of the fitting portion is located and having a normal line along a thickness direction of the fitting portion. The first side is a side configured to be in contact with the skin when the earphone is worn on the ear.

Other aspects and embodiments of the present disclosure are also expected. The above summary and the following detailed description are not intended to limit the present disclosure to any particular embodiment, but are merely intended to describe some embodiments of the present disclosure.

### BRIEF DESCRIPTION OF THE DRAWINGS

FIG. 1 illustrates a schematic view of an earphone viewed from a first perspective according to an embodiment of the present application.

FIG. 2 illustrates a schematic view of the earphone viewed from a second perspective according to an embodiment of the present application.

FIG. 3 illustrates a schematic view of a user's ear.

FIG. 4 illustrates a schematic view showing the earphone hung on the ear of the user according to an embodiment of the present application.

FIG. 5 illustrates a schematic view of the earphone viewed from a third perspective according to an embodiment of the present application.

FIG. 6 illustrates a schematic view of the earphone viewed from a fourth perspective according to an embodiment of the present application.

FIG. 7 illustrates a schematic view of the earphone viewed from a fifth perspective according to an embodiment of the present application.

FIG. 8 illustrates a schematic view of the earphone viewed from a sixth perspective according to an embodiment of the present application.

FIG. 9 illustrates a schematic view showing a position of a longitudinal center plane of the earphone according to an embodiment of the present application.

FIG. 10 illustrates a schematic view showing a relative position relationship between a battery portion and a fitting portion of the earphone within the longitudinal center plane according to an embodiment of the present application.

FIG. 11 illustrates a schematic view showing a relative position relationship between the earphone and the ear, viewed from an angle when the earphone is in a worn state according to an embodiment of the present application.

FIG. 12 illustrates a schematic view showing a relative position relationship between the earphone and the ear, viewed from another angle when the earphone is in a worn state according to an embodiment of the present application.

FIG. 13 illustrates a schematic view showing a relative position relationship between the battery portion and the fitting portion of the earphone within the longitudinal center plane according to an embodiment of the present application.

FIG. 14 illustrates an exploded view of the earphone according to an embodiment of the present application.

FIG. 15 illustrates a schematic view of the earphone in a worn state according to an embodiment of the present application.

### DETAILED DESCRIPTION

The technical solutions in the embodiments of the present disclosure will be clearly and completely described below with reference to the accompanying drawings in the embodiments of the present disclosure. Obviously, the described embodiments are part of the embodiments of the present disclosure, rather than all of the embodiments.

The various features described in the specific embodiments can be combined in a suitable way without contradiction, for example, different features can be combined to obtain different embodiments or technical solutions. In order to avoid unnecessary repetition, the combinations of the features in the present application will not be explained.

In the following description, the terms “first” and “second” are used to distinguish different objects and not to imply similarities or connections. It should be understood that the orientation descriptions “on”, “under”, “outside”, and “inside” refer to orientations in normal use, and the orientation descriptions “left” and “right” refer to orientations shown in the corresponding drawings, which may be or not be the left and right directions in normal use.

It should be noted that the terms “including”, “comprising” or any other variation intended to encompass non-exclusive inclusion, can describe that a process, a method, an article, or a device not only includes the related elements, but also includes other elements that are not explicitly listed or inherent elements in such a process, method, article, or device. Without further limitations, the element defined by the statement “including a . . . ” does not exclude the existence of other identical elements in the process, method, article, or device. The term “connect” includes direct and indirect connections unless otherwise specified.

In specific implementation, the earphone is suitable to be worn by any type of user. For example, the earphone can be worn by an adult male user, whose ears are often thick (commonly known as “thick ears”). The earphone can also be worn by an adult female users, whose ears are often thin (commonly known as “Thin ears”). The earphone can also be worn by an underage user, whose ears are relatively small compared to adult ears. Therefore, the earphones of the present application can meet the needs of various types of users. For the sake of clarity, the following illustrates the structure of the earphone taking the earphone as being worn by the male user for example. The adult male user will not have any impact on the structure of the earphone.

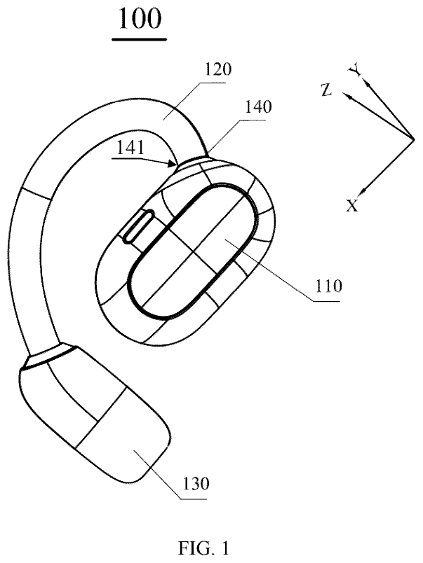

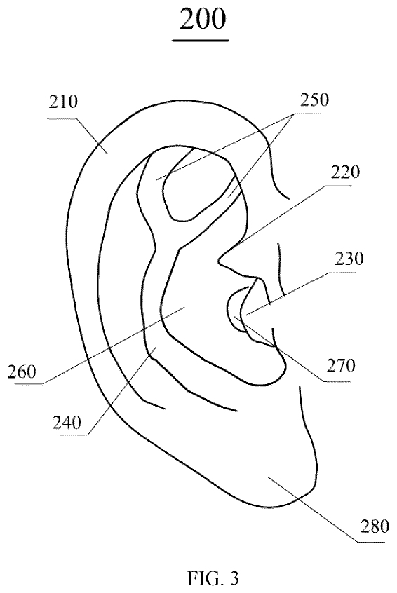

Specifically for the user, sound quality, comfort, and durability of the earphone 100 shown in FIG. 1 are concerned. In terms of sound quality, the listening experience of the earphone 100 is different from that of a loudspeaker. The sound waves emitted by the loudspeaker may attenuate and interfere in the air, and may also interact with the human head and ears. However, the sound from the earphone 100 directly enters the ear 200. The coordination between the earphone 100 and the ear 200 directly affects the sound quality. In terms of comfort, the earphone 100 should not be too tight or too loose to meet the needs of long-term wearing. Therefore, the coordination between the earphone 100 and the ear 200 directly affects the wearing comfort. In terms of durability, there is a certain demand for the battery life and manufacturing quality of the earphone 100. Also, when the earphone 100 is unstably worn, the earphone 100 may easily be separated from the ear to cause damages, which is also a part of the durability of the earphone 100. The earphone 100 of the present application is an open-back earphone, which can also be referred to as an on-ear earphone in terms of the manner of the earphone 100 to be worn. The It earphone 100 needs to be worn on the user's ear 200 through a connection portion 120. The following will provide a detailed description through specific embodiments in order to facilitate the description of a connection relationship between the earphone 100 and various parts of the ear 200, and to facilitate the understanding of the impact of the contact between the various parts of the earphone 100 and the various parts of the ear 200 on the sound quality, comfort, and durability. Firstly, the various parts of the ear 200 will be introduced. As shown in FIG. 3, the ear 200 includes a helix 210, a crus of helix 220, a tragus 230, an antihelix 240, a crus of antihelix 250, a cavum conchae 260, an ear canal 270, and an earlobe 280.

In some embodiments, as shown in FIGS. 1 to 4, the earphone 100 includes a fitting portion 110 and the connecting portion 120. The fitting portion 110 includes a sound outlet 111. The connection portion 120 extends along a curved direction.

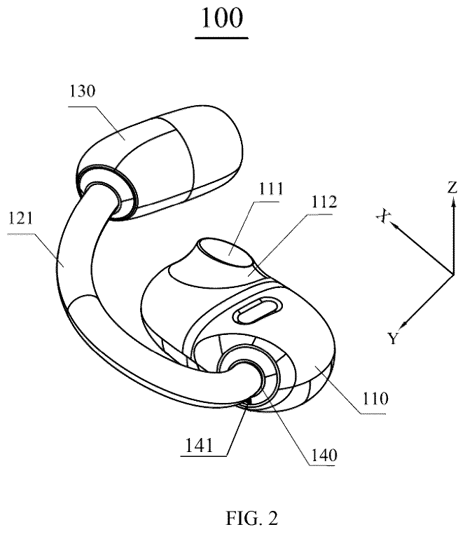

Specifically, in order to facilitate the explanation of the direction of the earphone 100, a coordinate system is established as shown in FIGS. 1 and 2, which can assist in understanding the structural positional relationship of the earphone 100 in a three-dimensional space. The three-dimensional space has three directions, that is, X direction, Y direction, and Z direction. The three-dimensional space also has three planes, that is, XY plane, XZ plane, and YZ plane, which facilitates the subsequent description. A length direction of the fitting portion 110 is the X direction, a width direction of the fitting portion 110 is the Y direction, and a thickness direction of the fitting portion 110 is the Z direction. A longitudinal center plane 150 is located at the XY plane, a transverse center plane 160 is located at the XZ plane, and a radial center plane 170 is located at the YZ plane. The earphone 100 includes multiple portions. The fitting portion 110 is one of the portions that can generate sound, and is equipped with a sound generation device (not shown) therein. The sound generation device includes various components such as a magnet, a coil, and a vibration diaphragm. Sound is generated by changing the state of the vibration diaphragm. A surface of the fitting portion 110 has a sound outlet 111. The sound outlet 111 is composed of multiple small holes. The quantity and size of the small holes are not limited and can be determined according to actual needs. The sound generated by the vibration diaphragms passes through the small holes of the sound outlet 111 toward the ear 200. The specific location of the sound outlet 111 is not limited and can be determined according to actual needs. For example, the sound outlet 111 may be located at an end portion of the fitting portion 110. The sound outlet 111 may also be located in a middle area of the periphery of the fitting portion 110. It should be noted that the fitting portion 110 has a certain thickness due to the presence of various components inside the fitting portion 110. The specific shape of the fitting portion 110 is not limited, and any structure that can accommodate the sound generation device can meet the requirements. For example, the fitting portion 110 may have a rectangular structure. In order to further improve the wearing comfort, the fitting portion 110 may also have an ellipsoidal structure.

The earphone 100 includes the connection portion 120. One end of the connection portion 120 is connected to the fitting portion 110. The connection portion 120 extends along a curved direction. The extension along the curved direction here may be understood as a curved structure. That is, the connection portion 120 starts from the front side of the ear 200, passes over the upper side of the ear 200, and extends along the auricle to the rear side of the ear 200. Thus, the connection portion 120 is attached to the upper and rear sides of the ear 200, so that the earphone 100 can be fixed to the ear 200. A cross-sectional size perpendicular to the extension direction of the connection portion 120 is not limited as long as it can meet the requirements. If the cross-sectional size is too large, the ear 200 may not be able to effectively fix the connection portion 120. If the cross-sectional size is too small, the contact area between the connection portion 120 and the ear 200 may be too small, and the gravity of the earphone 100 is concentrated on the small contact surface to result in discomfort during wearing. For example, the connection portion 120 has a circular cross-section perpendicular to its extension direction, and the cross-sectional size has a diameter of about 5 millimeters.

The material of the connection portion 120 can be, but not limited to plastic, rubber, etc. In order to better meet the wearing habits of different users, the connection portion 120 can be made of a memory material. Generally, the ear 200 of a male user is larger than the ear 200 of a female user, and the ear 200 of an adult user is larger than the ear 200 of an underage user. For different sizes of the ears 200, the bending degree of the connection portion 20 can be adjusted according to actual needs such that the connection portion 120 can better fit the ear 200 of different users. When the user wears the earphone 100 next time, there is no need to adjust the size of the earphone 100. The operation of earphone 100 will consume energy. For example, the earphone 100 may provide energy by the solar energy. The earphone 100 may also provide energy by the battery. When the earphone 100 provides energy by the battery, the installation position of the battery is not limited. For example, the earphone 100 further includes a battery portion 130. One end of the connection portion 120 is connected to the fitting portion 110, and another end of the connection portion 120 is connected to the battery portion 130. The battery is installed inside the battery portion 130 provides energy to the sound generation device inside the fitting portion 110.

Wherein, a connection position 140 between the connection portion 120 and the fitting portion 110 is located at a first side of the longitudinal center plane 150 of the fitting portion 110. When the earphone 100 is in the worn state, a connection surface 141 of the connection position 140 is inclined towards the user's skin. The longitudinal center plane 150 contains the geometric center point of the fitting portion 110, and the normal line of the longitudinal center plane 150 is parallel to the thickness direction of the fitting portion 110. The first side of the longitudinal center plane 150 is the side in contact with the user's skin when the earphone 100 is in the worn state. Specifically, the connection portion 120 extends along the auricle, and connected to the middle area of the fitting portion 110 along the thickness direction of the fitting portion 110. At the same time, since the connection portion 120 extending along and closely fits the auricle, but the fitting portion 110 has a larger thickness compared to that of the connection portion 120 due to the presence of the components such as sound generation device, the fitting portion 110 may press some portions of the ear 200, resulting in a decrease in comfort and wearing stability. Thus in the embodiment, the connection position 140 between the connection portion 120 and the fitting portion 110 is located on the first side of the longitudinal center plane 150 of the fitting portion 110, that is, when the earphone 100 is in the worn state, the connection position 140 between the connection portion 120 and the fitting portion 110 is located at a position of the fitting portion 110 closer to the ear 200. The connection surface 141 of the connection position 140 can be curved or flat. No matter the connection surface 141 of the connection position 140 is curved or flat, the connection surface 141 is inclined towards the user's skin.

With the above configuration of the present application, the earphone 100 includes the fitting portion 110 and the connecting portion 120. The fitting portion 110 includes the sound outlet 111. The connection portion 120 extends in a curved direction. Wherein, the connection position 140 between the connection portion 120 and the fitting portion 110 is located on the first side of the longitudinal center plane 150 of the fitting portion 110. When the earphone 100 is in the worn state, the connection surface 141 of the connection position 140 is inclined towards the user's skin. The longitudinal center plane 150 contains the geometric center point of the fitting portion 110, and the normal line of the longitudinal center plane 150 is parallel to the thickness direction of the fitting portion 110. The first side is the side in contact with the user's skin when the earphone 100 in the worn state. When the earphone 100 is in the worn state, the connection portion 120 can be hung between the rear side of the ear 200 and the head of the user. The fitting portion 110 can be in contact with the front side of the ear 200, such that the fitting portion 110 and the connection portion 120 cooperate to clamp the ear 200. The fitting portion 110 has components such as the sound emitting device installed therein, which causes the fitting portion 110 to have a certain thickness. When the connection portion 120 is directly hung on the ear 200, the fitting portion 110 may press and squeeze the crus of antihelix 250 inside the ear 200 and even the crus of antihelix 250, resulting in discomfort to the ear 200 after a long-term use and a decrease in wearing stability. By setting the connection position 140 between the connection portion 120 and the fitting portion 110 on the first side of the longitudinal center plane 150. Thus, it feels like the thickness of the fitting portion 110 is reduced when the user wears the earphone 100, thereby avoiding the squeeze of the fitting portion 110 to the crus of helix 220 and the crus of antihelix 250 inside the ear 200 and then improving the wearing comfort. At the same time, when the fitting portion 110 squeezes the ear 200, the crus of helix 220 and the crus of antihelix 250 inside the ear 200 may also squeeze the fitting portion 110 through the interaction of forces. Under the support force to the fitting portion 110 by the crus of helix 220 and the crus of antihelix 250, the actual position of the fitting portion 110 may be deviated, which in turn may cause the position of the connection portion 120 connected to the fitting portion 110 to be deviated, resulting in insufficient fit between the connection portion 120 and the rear side of the ear 200 or the head. This not only affects the wearing comfort at the rear side of the ear 200, but also reduces the wearing stability. By setting the connection position 140 between the connection portion 120 and the fitting portion 110 on one first side of the longitudinal center plane 150, the actual position of the fitting portion 110 is prevented from being deviated, thereby avoiding poor fitting between the connection portion 120 and the rear side of the ear 200 or the head, and improving the wearing stability.

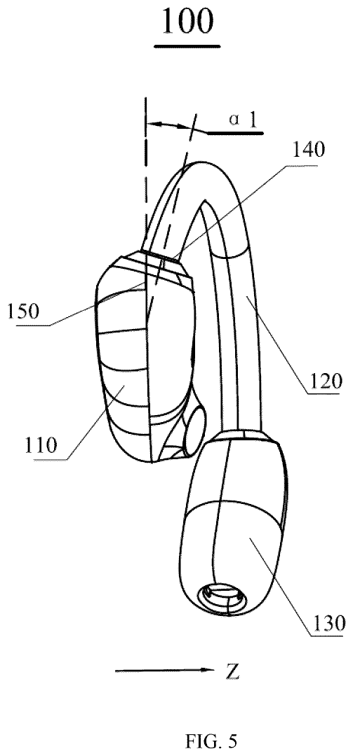

In some embodiments, as shown in FIG. 2, the connection surface 141 intersects with the longitudinal center plane 150. Specifically, the connection surface 141 of the connection position 140 can be a curved surface or a flat surface. The connection surface 141 intersecting with the longitudinal center plane 150 includes the situation that the connection surface 141 formed by the connection position 140 intersecting with the longitudinal center plane 150, and the connection surface here 141 is a surface with boundary. The connection surface 141 intersecting with the longitudinal center plane 150 also includes the situation that an extension surface of the connection surface 141 intersecting with the longitudinal center plane 150, and the surface here is a surface without boundary. For example, when the connection surface 141 is a curved surface, the extension direction of the connection surface 141 intersects with the longitudinal center plane 150. For example, when the connection surface 141 is flat, the connection surface 141 of the connection position 140 intersects with the longitudinal center plane 150. In some embodiments, as shown in FIG. 5, the angle between an extension direction of the connecting portion 120 from the connection position 140 and the longitudinal center plane 150 is in a range from 10 degrees to 30 degrees. Specifically, the connection position 140 between the connection portion 120 and the fitting portion 110 is located on the first side of the longitudinal center plane 150 of the fitting portion 110. When the user wears the earphone 100, it feels like the thickness of the fitting portion 110 is reduced, thereby avoiding pressing or squeezing the fitting portion 210 to the crus of helix 220 and the crus of antihelix 220 inside the ear 200, and improving the wearing comfort. In order to further improve the wearing comfort and to better fit the connection portion 120 or the fitting portion 110 to the ear 200, the angle between an extension direction of the connecting portion 120 from the connection position 140 and the longitudinal center plane 150 is set to be a first angle α1. The extension direction from the connection position 140 can be understood as that the connection portion 120 and the fitting portion 110 are connected at the connection position 140, the connection portion 120 extends outward from the connection position 140, and the direction along which the connection portion 120 extends outward from the connection position 140 is the extension direction. The first angle α1 is in a range from 10 degrees to 30 degrees. The connection portion 120 extends from the connection position 140 away from one end of the fitting portion 110. When the first angle α1 is 30 degrees, the deviation of the connection portion 120 from the fitting portion 110 is greater than when the first angle α1 is 10 degrees. Therefore, an degree of the connection portion 120 deviated from the fitting portion 110 when the first angle α1 is equal to 30 degrees is larger than that when first angle α1 is equal to 10 degrees. Thus, the earphone 100 is suitable for an adult male user (commonly known as “thick ears”) to wear when the first angle α1 is equal to 30 degrees, wherein the connection portion 120 and the fitting portion 110 can better fit the ear 200. The earphone 100 is also suitable for an adult female user (commonly known as “thin ears”) to wear the first angle α1 is equal to 10 degrees, wherein the connection portion 120 and the fitting portion 110 can better fit the ear 20.

In some embodiments, as shown in FIGS. 1 and 2, the connection position 140 is located at a second side of the transverse center plane 160 of the fitting portion 110. The transverse center plane 160 contains the geometric center point of the fitting portion 110, and the normal line of the transverse center plane 160 is parallel to the width direction of the fitting portion 110. The second side is the side away from the user's earlobe 280 when the earphone 100 is in the worn state. Specifically, the plane where the transverse center plane 160 is located is the XZ plane. The connection position 140 between the connection portion 120 and the fitting portion 110 is located at the first side of the longitudinal center plane 150 of the fitting portion 110, and when the earphone 100 is in the worn state, the connection position 140 between the connection portion 120 and the fitting portion 110 is at a position of the fitting portion 110 closer to the ear 200. Also, the connection position 140 between the connection portion 120 and the fitting portion 110 is located at the second side of the transverse center plane 160 of the fitting portion 110, which can also improve the wearing comfort, and its principle is the same as that when the connection position 140 is located at the first side of the longitudinal center plane of the fitting portion 110 and will not be repeated. In order to further improve the wearing comfort, the connection position 140 can meet both of the above situations. That is, the connection position 140 is located at the first side of the longitudinal center plane 150 of the fitting portion 110, and further at the second side of the transverse center plane 160 of the fitting portion 110, wherein the second side is the side away from the user's earlobe 280 when the earphone 100 is in the worn state. Just because the connection position 140 is located at the second side of the transverse center plane 160 of the fitting portion 110, when the earphone 100 is in the worn state, the connection portion 120 extends along the auricle, and the fitting portion 110 is connected to the connection portion 120, such that there is an angle between the length direction of the fitting portion 110 and the vertical direction. The specific value of the above angle is related to the connection position 140, and the connection position 140 ensures that the length direction of the fitting portion 110 is not perpendicular to the vertical direction. The fitting portion 110 is inclined downward and extends along the length direction, which can reduce the press or squeeze on the crus of antihelix 250 and even avoid any contact with the crus of antihelix 250. Thus, the wearing comfort can be further improved.

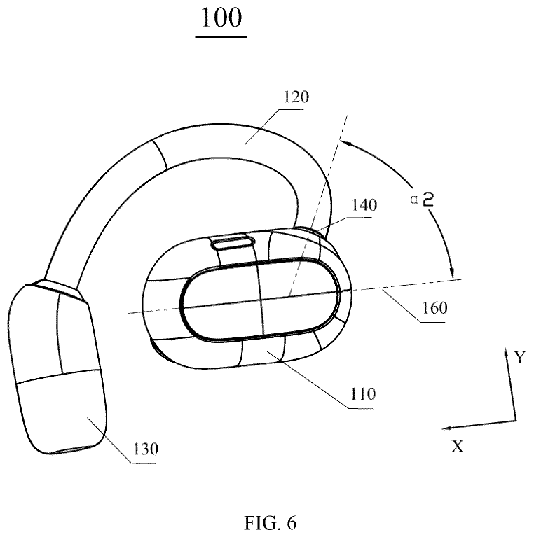

In some embodiments, as shown in FIG. 6, the angle between the extension direction of the connecting portion 120 from the connection position 140 and the transverse center plane 160 is in a range from 50 degrees and 70 degrees. Specifically, the connection position 140 between the connection portion 120 and the fitting portion 110 is located at the second side of the transverse center plane 160 of the fitting portion 110. When the user wears the earphone 100, there is an angle between the length direction of the fitting portion 110 and the vertical direction, which can reduce the press or squeeze on the crus of antihelix 250 and even avoid any contact with the crus of antihelix 250. In order to further improve the wearing comfort and better fit the connection portion 120 and the fitting portion 110 with the ear 200, the angle between the extension direction of the connection portion 120 from the connection position 140 and the transverse center plane 160 is set to be the second angle α2. The second angle is in a range from 50 degrees and 70 degrees. The fitting portion 110 extends along the length direction from the connection position 140. The smaller the second angle α2, the larger the downward inclination angle of the fitting portion 110, and the smaller the angle between the length direction of the fitting portion 110 and the vertical direction. Considering the specific structure of the ear 200, if the angle between the length direction of the fitting portion 110 and the vertical direction is too small, the fitting portion 110 may squeeze the tragus 230, resulting in wearing discomfort, and at the same time, there is no part in the earphone 100 to limit the position of the fitting portion 110, resulting in poor wearing stability. If the angle between the length direction of the fitting portion 110 and the vertical direction is too large, the fitting portion 110 may squeeze the crus of antihelix 250, resulting in wearing discomfort, and at the same time, change may occur in the position of the fitting portion 110 due to the crus of helix 220, thereby affecting the wearing stability. When the second angle α2 is equal to 70 degrees, the downward inclination angle of the fitting portion 110 may be suitable for the user with small ears 200. When the second angle α2 is equal to 50 degrees, the downward inclination angle of the fitting portion 110 may be suitable for the user with large ears 200.

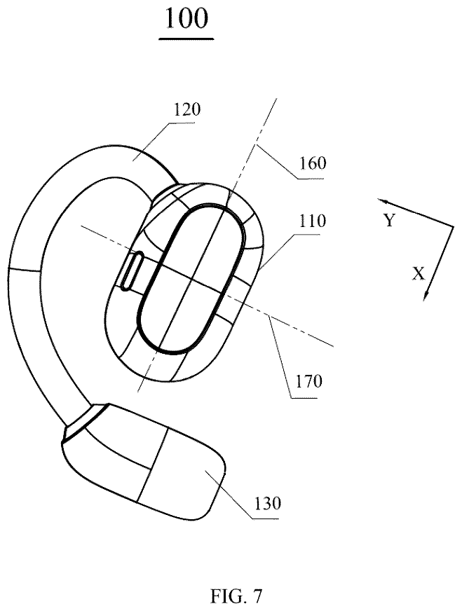

In some embodiments, as shown in FIG. 7, the connection position 140 is located at a third side of the radial center plane 170 of the fitting portion 110, wherein the radial center plane 170 contains the geometric center point of the fitting portion 110, and the normal line of the radial center plane 170 is parallel to the length direction of the fitting portion 110. The third side is the side away from the user's earlobe 280 when the earphone 100 is in the worn state. Specifically, the plane where the radial center plane 170 is located is the YZ plane. The connection position 140 between the connection portion 120 and the fitting portion 110 is located at the first side of the longitudinal center plane 150 of the fitting portion 110. When the earphone 100 is in the worn state, the connection position 140 between the connection portion 120 and the fitting portion 110 is located at a position of the fitting portion 110 closer to the ear 200. Also, the connection position 140 can be located at the first side of the longitudinal center plane 150 of the fitting portion 110 and further at the second side of the transverse center plane 160 of the fitting portion 110, and the second side is the side away from the user's earlobe 280 when the earphone 100 is in the worn state. Also, the connection position 140 can be located at the first side of the longitudinal center plane 150 of the fitting portion 110, and further at the second side of the transverse center plane 160 of the fitting portion 110 wherein the second side is the side away from the user's earlobe 280 when the earphone 100 is in the worn state, and further at the third side of the radial center plane 170 of the fitting portion 110 wherein the third side is the side away from the user's earlobe 280 when the earphone 100 is in the worn state. The connection position 140 is located at a position of the fitting portion 110 above the ear 200 and away from the earlobe 280. In some embodiments, as shown in FIG. 2, the sound outlet 111 is located at an end of the fitting portion 110 away from the connection position 140. The sound outlet 111 is also located at the side of the fitting portion 110 facing the connection portion 120. Specifically, the earphone 100 includes the fitting portion 110 and the connection portion 120. According to actual situation of the ear 200, when the earphone 100 is worn, the connection position 140 between the fitting portion 110 and the connection portion 120 is located at the end of the helix 210 near the crus of helix 220, wherein there is no cavity directly connected to the ear canal 270. In order to ensure effective sound transmission, the sound outlet 111 is arranged to be located at the end of the fitting portion 110 away from the connection position 140 and at the side of the fitting portion 110 facing the connection portion 120, such that sound can enter the ear canal 270 at the first time and avoid sound leakage.

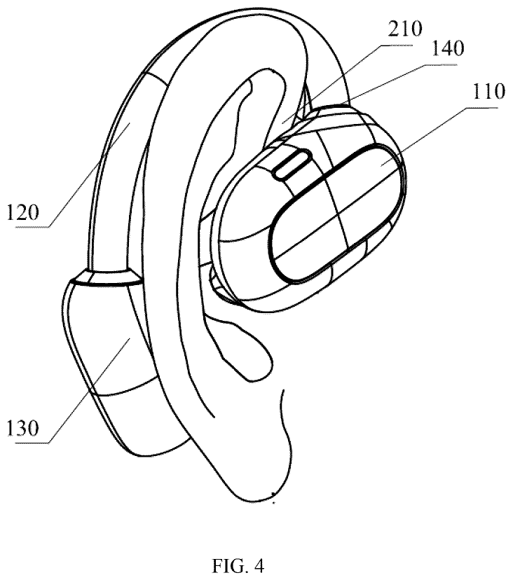

In some embodiments, as shown in FIGS. 3 and 4, when the earphone 100 is in the worn state, the fitting portion 110 is located between the helix 210 and the tragus 230, and the fitting portion 110 is in contact with the end of the helix 210 near the crus of helix 220. Specifically, the earphone 100 is mainly hung on the ear 200 through the connection portion 120. The ear 200 can limit the position of the connection portion 120 to prevent the connection portion 120 from being separated from the ear 200. However, shaking may also happen to the fitting portion 110 during movement. The shaking of the fitting portion 110 may cause the sound heard by the user from the fitting portion 110 to be unstable, and such sound also be accompanied by noise from air flow. Considering the above fact and the structure of the ear 200, the embodiment of the present application arranges the fitting portion 110 to be located between the helix 210 and the tragus 230 when the earphone 100 is in the worn state, and the fitting portion 110 is in contact with the end of the helix 210 near the crus of helix 220. Since the position of the fitting portion 110 of the earphone 100 is limited by the helix 210 and the tragus 230, the fitting portion 110 is prevented from moving. It should be noted that the specific part having position limiting function is the position of the helix 210 near the crus of helix 220 and one side of the tragus 230. The fitting portion 110 is in contact with one side of the tragus 230, which means that there will not be or will be a squeezing force between the fitting portion 110 and the tragus 230.

In some embodiments, as shown in FIGS. 3 and 4, a side of the fitting portion 110 along the thickness direction of the fitting portion 110 near the head resists against the tragus 230. Specifically, neural distribution on the ear 200 is less than that on the head, thus the sensitivity of the ear 200 is poorer compared to the head. The tragus 230 is directly connected to the head, such that the tragus 230 has richer neural network compared to other parts of the ear 200. In order to improve the sound quality obtained by user, the tragus 230 is used to effectively limit the position of the fitting portion 110. The side of the fitting portion 110 along the thickness direction of the fitting portion 110 near the head resists against the tragus 230. By arranging the fitting portion 110 to be resisted against the tragus 230, the tragus 230 can cooperate with the helix 210 to limit the position of the fitting portion 110, and the sound generated by the sound generation device in the fitting portion 110 can pass through the tragus 230 through bone conduction to the ear 200, which can reduce the loss of sound transmission and ensuring the quality of sound transmission.

In some embodiments, as shown in FIGS. 3 and 4, when the earphone 100 is in the worn state, the fitting portion 110 extends along the length direction to the cavum conchae 260. One end of the fitting portion 110 is close to the antihelix 240. Specifically, in order to ensure that the sound from the sound outlet 111 can be transmitted to the user better and to avoid the spread of sound and external interference as much as possible, the fitting portion 110 extends along the length direction to the cavum conchae 260 when the earphone 100 is in the worn state. The cavum conchae 260 is a cavity communicating with the ear canal 270. When the sound outlet 111 transmits the sound into the cavum conchae 260, the sound travels from the cavum conchae 260 to the ear canal 270. Also, the antihelix 240 and the crus of antihelix 250 cooperatively define the cavum conchae 260. One end of the fitting portion 110 is close to the antihelix 240, which can effectively prevent the sound emitted by the sound outlet 111 and entering the cavum conchae 260 from being leaked out, and also effectively prevent external air from blowing into the cavum conchae 260 and causing interference to the sound, thereby ensuring sound quality to a certain extent. The degree to which the end of the fitting portion 110 is close to the antihelix 240 is not limited. For example, for the user with a small cavum conchae 260, the end of the fitting portion 110 may come into contact with the antihelix 240. For the user with a larger cavum conchae 260, the end of the fitting portion 110 may be a few millimeters away from the antihelix 240. The actual situation may be varied from person to person.

In some embodiments, as shown in FIG. 5, a thickness of the fitting portion 110 gradually decreases from the connection position 140 along the length direction. Specifically, when the earphone 100 is worn on the ear 200 for a long time, the heavier the earphone 100, the greater the pressure on the ear 200, and the worse the user's comfort. In order to ensure the user's experience and reduce the weight of the earphone 100 as much as possible, the thickness of the fitting portion 110 gradually decreases from the connection position 140 along the length direction. By reducing the thickness of the fitting portion 110, the pressure on the ear 200 is alleviated to a certain extent. It should be emphasized that the thickness of the fitting portion 110 gradually decreases from the connection position 140 along the length direction, which does not mean that the distance between the sound outlet 111 and the ear canal 270 is farther. Just because the connection position 140 between the connection portion 120 and the fitting portion 110 is located at the first side of the longitudinal center plane 150 of the fitting portion 110, when the fitting portion 110 extends along the length direction, the fitting portion 110 can be deviated towards the inner side of the cavum conchae 260. This can be simply understood as that the thickness of the fitting portion 110 is reduced by thinning the side of the fitting portion 110 away from the ear 200, rather than thinning the side of the fitting portion 110 closer to the ear 200.

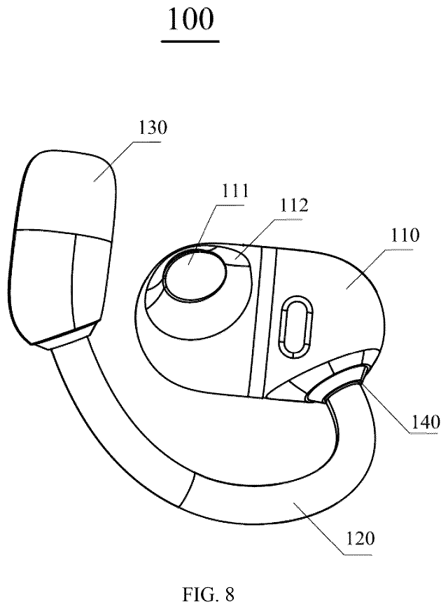

In some embodiments, as shown in FIG. 8, a sound generation protrusion 112 is provided on the fitting portion 110, which is located at one end of the fitting portion 110 along the length direction away from the connection position 140. The sound outlet 111 is provided on the sound generation protrusion 112. Specifically, in order to further improve the sound receiving effect by the user and reduce sound leakage, the sound generation protrusion 112 is provided on the end of the fitting portion 110 that is far away from the connection position 140 along the length direction of the fitting portion 110. This can be simply understood as that the end of the fitting portion 110 protrudes towards the inner side of the cavum conchae 260 to form the sound generation protrusion 112, and the sound outlet 111 is provided on the sound generation protrusion 112. Thus, the sound outlet 111 can be closer to the ear canal 270, thereby reducing the distance between the sound outlet 111 and the ear canal 270. After the sound is emitted from the sound outlet 111, the sound can travel into the ear canal 270 in a short time, which can reduce the time the sound stays in the cavum conchae 260 and also reduce the sound leakage as much as possible. The specific structure and size of the sound generation protrusion 112 are not limited, and can be determined according to actual needs. For example, the sound generation protrusion 112 is a cylinder, and the sound outlet 111 is located on a top surface of the cylinder.

In some embodiments, as shown in FIG. 8, when the earphone 100 is in the worn state, there is an angle between the top surface of the sound generation protrusion 112 and the vertical plane, such that the top surface can face the ear canal 270. Specifically, in order to make precise improvements to the earphone 100, the fact that the ear canal 270 of the ear 200 is hidden behind the tragus 230, the sound generation protrusion 112 extends towards the inner side of the cavum conchae 260, the top surface of the sound generation protrusion 112 does not directly face the ear canal 270, should be considered. In order to further reduce the distance between the sound outlet 111 and the ear canal 270, the top surface of the sound generation protrusion 112 is tilted to create an angle between the top surface of the sound generation protrusion 112 and the vertical plane. Thus, the top surface of the sound generation protrusion 112 can face the ear canal 270. After the sound is transmitted from the sound outlet 111, the sound directly enters the ear canal 270 along a straight line. The value of the angle between the top surface of the sound generation protrusion 112 and the vertical plane is not limited, and can be adjusted according to the type of user wearing the earphone 100. For example, the angle between the top surface of the sound generation protrusion 112 and the vertical plane is equal to 20 degrees.

In some embodiments, as shown in FIG. 8, the sound generation protrusion 112 gradually narrows along a direction away from the fitting portion 110, such that at least a portion of the sound generation protrusion 112 can be in contact with the cavum conchae 260. Specifically, after the above precise improvements to the earphone 100, the sound generation protrusion 112 can effectively transmit sound, shorten the transmission distance, and reduce the leakage of sound. Considering the internal structure of the ear 200, the sound generation protrusion 112 may interfere with the crus of helix 220 or other parts of the ear 200, such that the crus of helix 220 or other parts of the ear 200 may be squeezed, reducing the user's experience and affecting the wearing stability. In order to improve the above situation, the sound generation protrusion 112 gradually narrows in the direction away from the fitting portion 110, which can be simply understood as that when the sound generation protrusion 112 extends towards the cavum conchae 260, a cross-sectional area of the extended end of the sound generation protrusion 112 gradually decreases, thereby avoiding any interference between the sound generation protrusion 112 and the crus of helix 220 or other parts of the ear 200. When the relevant parts of the earphone 100 are only in contact with the ear 200 and there is no force therebetween, the earphone 100 will not cause discomfort to the ear 200. The side or top surface of the sound generation protrusion 112 being in contact with the cavum conchae 260 will not affect the wearing comfort. Therefore, the sounding protrusion 112 gradually narrows as the sounding protrusion 112 extends towards the cavum conchae 260, such that the sounding protrusion 112 can at least partially be in contact with the cavum conchae 260.

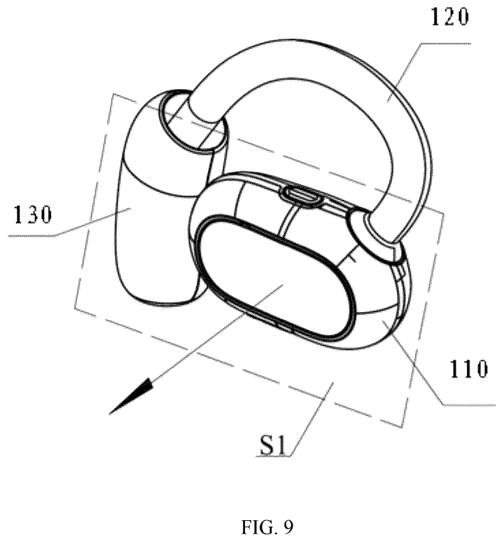

In some embodiments, as shown in FIG. 9, the fitting portion 110 is connected to one end of the connection portion 120. When the earphone 100 is worn, the fitting portion 110 can come into contact with the user's upper ear root, such that the fitting portion 110 and the connection portion 120 can together transmit the weight of the earphone 100 to the user's ear 200 or face. At the same time, the fitting portion 110 has a receiving cavity for receiving the sound generation device. The sound generation device can convert electrical signals into mechanical vibrations and excite the air inside the receiving cavity to vibrate through the mechanical vibrations. The vibration of the air is output from the fitting portion 110 and transmitted to the user's ear 200, which causes the user's eardrum to vibrate such that the user can hear the sound. By controlling the waveform of the electrical signals, the state of the mechanical vibrations of the sound generation device can be controlled, thereby allowing the user to hear the desired sound. The battery portion 130 is connected to an opposite end of the connection portion 120 away from the fitting portion 110. That is, the battery portion 130 and the fitting portion 110 are fixed to two opposite ends of the connection portion 120. The battery portion 130 can provide electrical energy to electronic control components or sound generation device inside the fitting portion 110, through some power supply structures arranged inside the connection portion 120. Thus, the electronic control components can drive the sound generation device to vibrate and produce sound, thereby enabling the fitting portion 110 to output sound. Wherein, the position where the fitting portion 110 is connected to the connection portion 120 is located on one side of the central axis along the width direction of the fitting portion 110, thereby forming a first side portion 113 of the fitting portion 110. Along the length direction of the fitting portion 110, the side of the fitting portion 110 opposite to the first side portion 113 is a second side portion 114. It can be understood that along the length direction of the fitting portion 110, the first side portion 113 and the second side portion 114 of the fitting portion 110 are located at two sides of the central axis along the width direction of the fitting portion 110, respectively. The position where the fitting portion 110 is connected to the connection portion 120 is located at the first side portion 113. At the same time, within the longitudinal center plane 150 of the fitting portion 110, the battery portion 130 is located at an outer side of the outer periphery of the second side portion 114 of the fitting portion 110. That is, along the length direction of the fitting portion 110, the projection of the battery portion 130 onto the longitudinal center plane 150 is located at the second side portion 114 of the central axis along the width direction of the fitting portion 110. Along the direction pointing from the first side portion 113 to the second side portion 114, the above projection of the battery portion 130 is located outside the space enclosed by the outer periphery of the fitting portion 110. That is, there is no overlap between the above projection of the battery portion 130 and the space enclosed by the outer periphery of the fitting portion 110. By arranging the projection of the battery portion 130 not to overlap with the outer periphery of the fitting portion 110, the clamping force applied to the ear 200 by the battery portion 130 and the fitting portion 110 can be reduced when the earphone 100 is in the worn state, thereby improving the wearing stability. The principle of improving the wearing stability by arranging the projection of the battery portion 130 not to overlap with the outer periphery of the fitting portion 110 will be explained below. When the earphone 100 is in the worn state, the fitting portion 110 and the battery portion 130 are located at the front side and the rear side of the ear 200, respectively, which will apply a force to the ear 200 along the thickness direction of the ear 200. Thus, the relative movement of the earphone 100 along the thickness direction of the ear 200 can be limited. At the same time, along a horizontal direction that is perpendicular to the thickness direction of the ear 200 and perpendicular to the vertical direction, the fitting portion 110 and the battery portion 130 are also located at two opposite sides of the ear 200, and the longitudinal center plane 150 of the fitting portion 110 is parallel to the horizontal direction. By arranging the projection of the battery portion 130 onto the longitudinal center plane not to overlap with the outer periphery of the fitting portion 110, the battery portion 130 and the fitting portion 110 will not apply any clamping force to the user's ear 200 along the horizontal direction. Along the length direction of the fitting portion 110, there is a gap between the projection of the outer periphery of the fitting portion 110 onto the longitudinal center plane 150 and the projection of the outer periphery of the battery portion 130 onto the longitudinal center plane 150. Thus, when the earphone 100 is worn, the force applied onto the ear 200 by the battery portion 130 and the fitting portion 110 can be reduced, thereby reducing the pain caused by the earphone 100 when the earphone 100 is in the worn state and improving the wearing comfort.

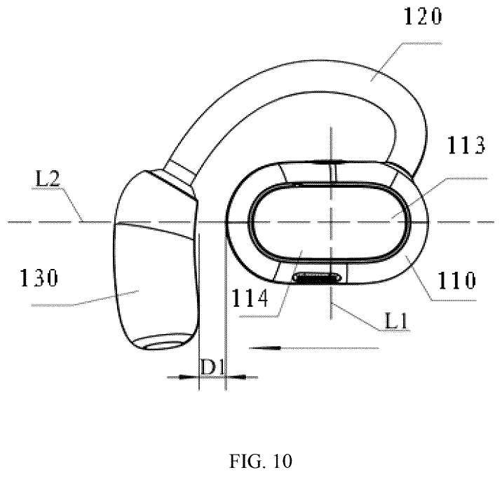

In some embodiments, as shown in FIG. 10, within the longitudinal center plane 150, the minimum distance between the outer periphery of the battery portion 130 and the outer periphery of the fitting portion 110 along the length direction of the fitting portion 110 is greater than 5 millimeters and less than 9 millimeters. This can be understood as that the projection of the fitting portion 110 and the battery portion 130 onto the longitudinal center plane 150 form the outer contour of the fitting portion 110 and the outer contour of the battery portion 130. Different points on the two outer contours form different distances along the length direction of the fitting portion 110, wherein the maximum value among the above distances is 9 millimeters, and the minimum value among the above distances is 5 millimeters. The distance between the fitting portion 110 and the battery portion 130 is maintained within an appropriate range. Thus, the earphone 100 can be prevented from separating from the user's ear 200 under a too large distance between the fitting portion 110 and the battery portion 130. Also, an excessive clamping force on the ear 200 that affects the wearing stability can be avoided under a too small distance between the fitting portion 110 and the battery portion 130.

In some embodiments, as shown in FIG. 10, within the longitudinal center plane 150, the central axis along the length direction of the fitting portion 110 passes through the space enclosed by the outer periphery of the battery portion 130. When the earphone 100 is in the worn state, the fitting portion 110 and the battery portion 130 should clamp the ear 200 along the thickness direction of the ear 200 to improve the wearing stability. If the central axis along the length direction of the fitting portion 110 does not pass through the space enclosed by the outer periphery of the battery portion 130, the fitting portion 110 and the battery portion 130 not only applies a clamping force to the ear 200 along the thickness direction of the ear 200, but also causes additional torsional torque to the ear 200, which will affect the wearing stability. When the earphone 100 is not in the worn state, the central axis along the length direction of the fitting portion 110 passes through the space enclosed by the outer periphery of the battery portion 130, which can reduce the deformation of the connection portion 120. Thus, when the earphone 100 is in the worn state, the central axis along the length direction of the fitting portion 110 passes through the space enclosed by the outer periphery of the battery portion 130, thereby reducing the force applied onto the ear 200 due to the deformation of the connection portion 120 and further improving the wearing comfort.

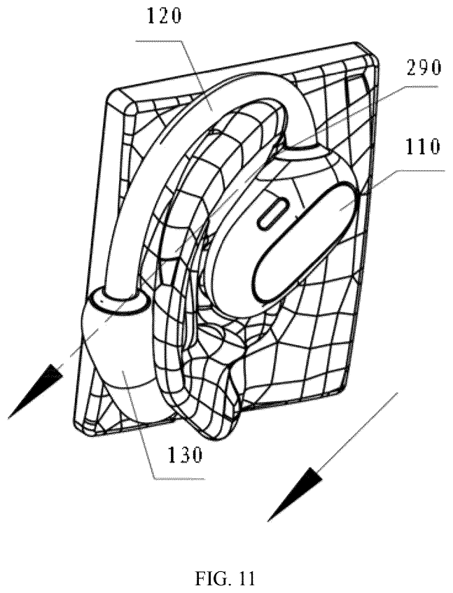

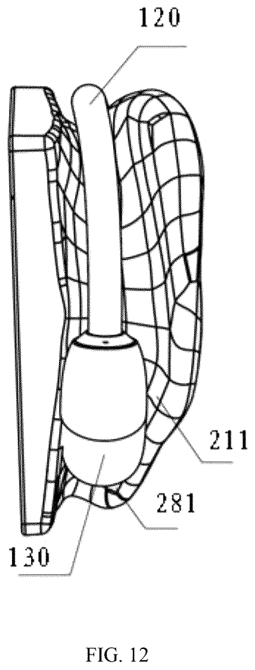

In some embodiments, as shown in FIG. 11, when the earphone 100 is in the worn state, the fitting portion 110 is in contact with the upper ear root 290 of the ear 200. As shown in FIG. 12, the battery portion 130 resists against a back surface 211 of the helix tail and/or a back surface 281 of the earlobe 280 of the ear 200. That is, when the earphone 100 is in the worn state, the connection portion 120 extends along the curve of the rear side of the helix 210 of the ear 200 to a position close to the rear side of the earlobe 280 of the ear 200. Thus, the battery portion 130 can be resisted against the back surface 211 of the helix tail or the back surface 281 of the earlobe 280, or partially resisted against the back surface 211 of the helix tail and partially resisted against the back surface 281 of the earlobe 280. That is, the contact position between the fitting portion 110 and the ear 200 and the contact position between the battery portion 130 and the ear 200 are located at two ends of the fitting portion 110 along the length direction of the ear 200. Thus, the reliability of wearing is improved, and the earphone 100 is not easily separated from the ear 200. At the same time, at the rear side of the ear 200, the back surface 211 of the helix tail and the back surface 281 of the earlobe 280 are less sensitive to external forces compared to other parts of the rear side of the ear 200. The back surface 211 of the helix tail and the back surface 281 of the earlobe 280 are also softer than other parts of the rear side of the ear 200, making it possible to produce greater deformation. Thus, when battery portion 130 is set to be resisted against the back surface 211 of the helix tail and the back surface 281 of the earlobe 280, the earphone 100 can reliably be worn on the ear 200 while reducing the pain on the rear side of the ear 200, thereby further improving the wearing comfort.

In some embodiments, as shown in FIG. 11, when the earphone 100 is in the worn state, within the longitudinal center plane 150, a resisting vector of the fitting portion 110 points to a portion where the battery portion 130 resists against the ear 200. Wherein, the resisting vector is a vector starting from a point where the fitting portion 110 resists against the upper ear root 290, and the direction of the resisting vector is the length direction of the fitting portion 110. That is, a component of the resisting force applied onto the upper ear root 290 by the fitting portion 110 points to the battery portion 130, wherein the component of the resisting force is along the length direction of the fitting portion 110. Thus, the component of the resisting force applied by the fitting portion 110 onto the contact position between the fitting portion 110 and the upper ear root 290 along the length direction of the fitting portion 110, is collinear with the component of the force applied by the battery portion 130 onto the ear 200 along the length direction of the fitting portion 110. Thus, an additional torque, which is caused by non-collinearity of the force between the fitting portion 110 and the ear 200 and the force between the battery portion 130 and the ear 200, can be reduced or avoided, thereby further improving the wearing comfort.

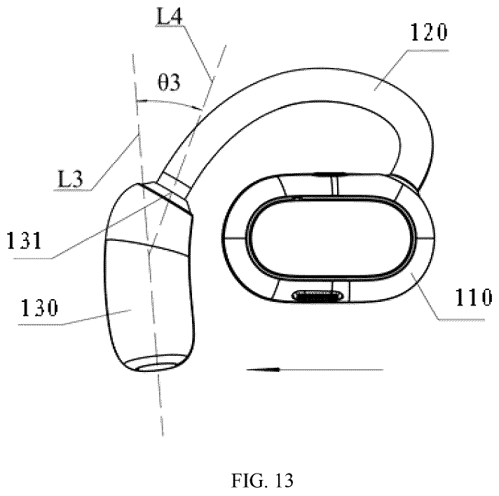

In some embodiments, as shown in FIG. 13, a geometric center of the connection surface where the battery portion 130 is connected to the connection portion 120, is located at a side of the central axis L3 of the battery portion 130 along the length direction of the battery portion 130 close to the fitting portion 110. This can be understood that the position where the battery portion 130 is connected to the connection portion 120 is not aligned with the central axis L3 of the battery portion 130, but instead deviated towards one side of the fitting portion 110. Thus, the orientation of the position where the battery portion 130 is connected to the connection portion 120 can adapt to the extension direction of the connection portion 120. If the position where the battery portion 130 is connected to the connection portion 120 is not deviated towards the fitting portion 110, it may require a larger inclination angle at the end of the connection portion 120 so that the above end of the connection portion 120 can be connected to the battery portion 130. Such the inclination angle will result in an increase of the length of the connection portion 120, which then limits the inclination angle of the end of the battery portion 130. If the position where the battery portion 130 is connected to the connection portion 120 is not deviated towards the fitting portion 110, it may also require the connection portion 120 to have a larger angle of a bending structure so that the connection portion 120 can be connected to the battery portion 130. Such the bending structure will result in an increase of the manufacturing cost of the connection portion 120, and the service life of the connection portion 120 may also be reduced due to internal stress generated after assembling the connection portion 120 to the battery portion 130.

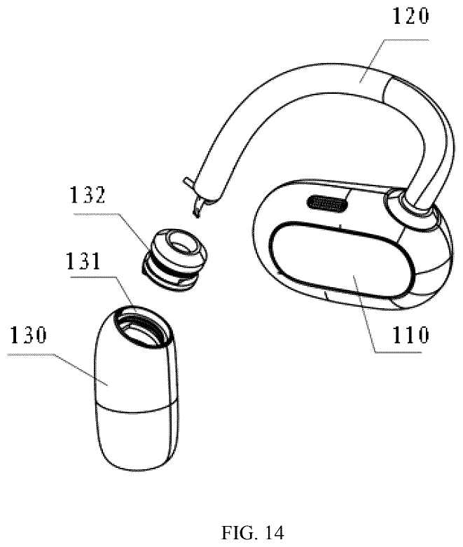

In some embodiments, as shown in FIG. 14, the battery portion 130 includes a plug hole 131. The end of the connection portion 120 is connected to the battery portion 130 through the plug hole 131. It can be understood that the end of the connection portion 120 is inserted into the plug hole 131 to achieve insertion of the connection portion 120 into the battery portion 130, and compared to fixing the connection portion 120 to the outer surface of the battery portion 130, the installation of the connection portion 120 to the battery portion 130 by insertion can reduce the stress concentration caused by possible sudden change in the cross-sectional shapes of the connection portion 120 and the outer surface of the battery portion 130, while eliminating the need for an additional transition structure between the battery portion 130 and the connection portion 120. Thus, the manufacturing cost of earphone 100 can be reduced, and the reliability of the connection between the connection portion 120 and the battery portion 130 can be improved. Moreover, compared to gluing the connection portion 120 to the battery portion 130 or integrally forming the connection portion 120 with the battery portion 130, the installation of the connection portion 120 to the battery portion 130 by insertion further facilitate the assembly and disassembly of the connection portion 120 and the battery portion 130, so that the connection portion 120 is easily replaced when damages happen on the connection portion 120.

At the same time, as shown in FIG. 13, within the longitudinal center plane 150, a predetermined angle is formed between the central axis L4 along the depth direction of the plug hole 131 and the central axis L3 along the length direction of the battery portion 130. This can be understood as the depth direction of the plug hole 131 being inclined relative to the central axis L3 of the battery portion 130. Thus, the depth direction of the plug hole 131 matches the inclination direction of the end of the connection portion 120. Specifically, a part of the central axis L4 along the depth direction of the plug hole 131 outside the battery portion 130, is located at one side of the central axis L3 along the length direction of the battery portion 130 close to the fitting portion 110. That is, a connection surface of the plug hole 131 formed on the outer surface of the battery portion 130 is inclined towards the fitting portion 100. This facilitates the insertion of the end of the connection portion 120 into the plug hole 131, thereby connecting the connection portion 120 to the battery portion 130.

In some embodiments, as shown in FIG. 13, the angle θ1 between the central axis L4 along the depth direction of the plug hole 131 and the central axis L3 along the length direction of the battery portion 130 is in a range from 25 degrees to 40 degrees. This can be understood when the angle between the axis along the depth direction of the plug hole 131 and the axis along the length direction of the battery portion 130 is within an appropriate a range, the inclination angle of the plug hole 131 can better match the inclination direction of the end of the connection portion 120. Also, the dimension of the battery portion 130 along the length direction thereof can fully be utilized to form the plug hole 131, such that the plug hole 131 has a sufficient depth, thereby allowing a sufficient length of the connection portion 120 to be inserted into the plug hole 131 to make the insertion of the connection portion 120 into the battery portion 130 reliable.

In some embodiments, as shown in FIG. 14, the earphone 100 further includes a connection ring 132. The connection ring 132 is sleeved on the end of the connection portion 120. The connection ring 132 and the end of the connection portion 120 are inserted into the plug hole 131, thereby fixing to the battery portion 130. Optionally, the connection portion 120 is detachably connected to the connection ring 132. During the installation of the connection portion 120, the connection ring 132 can be first fixed to the end of the connection portion 120, and the connection ring 132 and the connection portion 120 can together be connected to the battery portion 130. Alternatively, the connection ring 132 may first be installed into the plug hole 131, and the connection portion 120 may then be inserted into the connection ring 132, thereby fixing the connection portion 120 to the connection ring 132.

Optionally, the earphone 100 further includes a sealing component. The sealing component can block the gap between the end of the connection portion 120 and the inner sidewall of the plug hole 131. Thus, external liquid or dust are prevented from entering the interior of the battery portion 130 through the gap between the inner sidewall of the plug hole 131 and the end of the connection portion 120, thereby reducing damages to the battery inside the battery portion 130 caused by poor contact or short circuit, and extending the service life of the battery portion 130. It should be noted that the sealing component can be used in any suitable way to seal the gap between the end of the connection portion 120 and the inner sidewall of the plug hole 131. Optionally, the sealing component can be located at the outer surface of the battery portion 130, thereby blocking the gap between the end of the connection portion 120 and the plug hole 131 at the outer surface of the battery portion 130, and facilitating the installation and removal of the sealing component. Optionally, the sealing component may also be located inside the battery portion 130, and blocks the gap between the end of the connection portion 120 and the inner sidewall of the plug hole 131 at the inside of the battery portion 130, thereby reducing the possibility of the sealing component separating from the outer surface of the battery portion 130. Optionally, the sealing component may also be located inside the plug hole 131 and between the end of the connection portion 120 and the inner sidewall of the plug hole 131, thereby sealing the gap between the end of the connection portion 120 and the inner sidewall of the plug hole 131. When the sealing component is located inside the plug hole 131, the sealing component may be an elastic component sandwiched between the outer surface of the end of the connection portion 120 and the inner sidewall of the plug hole 131. Through the elastic deformation of the sealing component, the sealing component can be resisted against the outer surface of the end of the connection portion 120 and the inner sidewall of the plug hole 131reliably, thereby enhancing the sealing effect between the end of the connection portion 120 and the inner sidewall of the plug hole 131 by the sealing component.

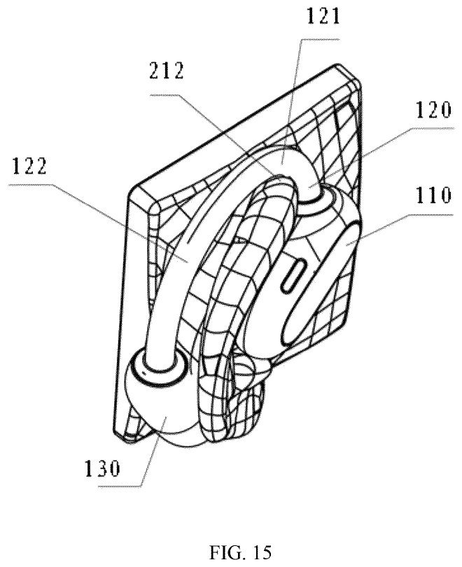

In some embodiments, as shown in FIG. 15, at least a portion of the connection portion 120 is an elastic portion 122 that can generate elastic deformation. It can be understood that at least a portion of the connection portion 120 is the elastic portion 122 that can generate elastic deformation, such that when the earphone 100 is worn, the connection portion 120 can be adjusted according to the user's ears 200 with different sizes. For example, when the earphone 100 is worn on the thick ear of an adult male, the elastic portion 122 of the connection portion 120 can generate greater elastic deformation along the thickness direction of the ear 200, such that the fitting portion 110 and the battery portion 130 are farther apart from each other along the thickness direction of the ear 200, thereby reducing the clamping force applied by the connection portion 120 onto the ear and improving the user's wearing stability. For example, when the earphone 100 is worn on the thin ear 200 of an underage woman, the elastic portion 122 of the connection portion 120 can produce smaller elastic deformation along the thickness direction of the ear 200, such that the connection portion 120 and the battery portion 130 are at a smaller distance from each other along the thickness direction of the ear 200, thereby allowing the connection portion 120 to apply a clamping force to the ear 200 through elastic deformation and improving the user's wearing stability.

At the same time, as shown in FIG. 2, when the earphone 100 is worn, the connection portion 120 resists against the back surface 212 of the helix 210 near the upper ear root 290 to form a position 121. The position 121 is where the connection portion 120 resists against the back surface 212 of the helix 210. The elastic portion 122 of the connection portion 120 extends from the position 121 to the end of the connection portion 120 connected to the battery portion 130. It can be understood that the length of the elastic portion 122 accounts for a part of the length of the connection portion 120, and the elastic portion 122 extends from the position 121 to the end of the connection portion 122 connected to the battery portion 130, such that the elastic portion is long enough for the connection portion 120 to produce a sufficient elastic deformation. Furthermore, since the elastic portion 122 is in contact with the ear 200, the hard contact between the connection portion 120 and the ear 200 can be reduced, thereby further reducing the wearing stability.

The above description is only a preferred embodiment of the present disclosure and is not intended to limit the present disclosure. Any modifications, equivalent substitutions and improvements made within the principles of the present disclosure should be included in the protection scope of the present disclosure.

What is claimed is:

1. An earphone with wearing stability, comprising:
a fitting portion comprising a sound outlet; and
a connection portion connected to the fitting portion and extending along a curved direction,
wherein a connection position between the connection portion and the fitting portion is located at a first side of a longitudinal center plane of the fitting portion, a connection surface of the connection position is inclined towards skin of a user skin when the earphone is worn on an ear of the user, wherein the longitudinal center plane contains a geometric center point of the fitting portion, a normal line of the longitudinal center plane is parallel to a thickness direction of the fitting portion, and the first side of the longitudinal center plane is configured to be in contact with the skin when the earphone is worn on the ear.

2. The earphone according to claim 1, wherein the connection surface intersects with the longitudinal center plane.

3. The earphone according to claim 2, wherein an angle between an extension direction of the connecting portion starting from the connection position and the longitudinal center plane is in a range from 10 degrees to 30 degrees.

4. The earphone according to claim 1, wherein the connection position is further located at a second side of a transverse center plane of the fitting portion, the transverse center plane contains the geometric center point of the fitting portion, a normal line of the transverse center plane is parallel to a width direction of the fitting portion, and the second side of a transverse center plane is away from an earlobe of the ear when the earphone is worn on the ear.

5. The earphone according to claim 4, wherein an angle between an extension direction of the connecting portion starting from the connection position and the transverse center plane is in a range from 50 degrees to 70 degrees.

6. The earphone according to claim 4, wherein the connection position is further located at a third side of a radial center plane of the fitting portion, the radial center plane contains the geometric center point of the fitting portion, a normal line of the radial center plane is parallel to a length direction of the fitting portion, and the third side of the radial center plane is away from an earlobe of the ear when the earphone is worn on the ear.

7. The earphone according to claim 1, wherein the fitting portion is configured to be located between a helix and a tragus of the ear, and in contact with an end of a helix near a crus of helix of the ear, when the earphone is worn on the ear.

8. The earphone according to claim 7, wherein along the thickness direction of the fitting portion, a side of the fitting portion near a head of the user is configured to resist against the tragus.

9. The earphone according to claim 1, wherein the fitting portion is configured to extend along a length direction of the fitting portion to a cavum conchae of the ear, and an end of the fitting portion is configured to be close to an antihelix of the ear, when the earphone is worn on the ear.

10. The earphone according to claim 1, wherein a thickness of the fitting portion gradually decreases from the connection position along a length direction of the fitting portion.

11. The earphone according to claim 1, wherein the fitting portion further comprises a sound generation protrusion, the sound generation protrusion is located at an end of the fitting portion away from the connection position along a length direction of the fitting portion, the sound outlet is provided on the sound generation protrusion, an angle is formed between a top surface of the sound generation protrusion and a vertical plane when the earphone is worn on the ear, and the top surface of the sound generation protrusion is configured to face an ear canal of the ear.

12. The earphone according to claim 11, wherein the sound generation protrusion gradually narrows along a direction away from the fitting portion, and the sound generation protrusion is configured to be at least partially in contact with an ear canal of the ear.

13. The earphone according to claim 1, wherein the fitting portion is connected to an end of the connection portion, a position where the fitting portion is connected to the connection portion is located at a side of a central axis of the fitting portion along a width direction of the fitting portion, the side of the central axis is defined as a first side portion of the fitting portion;
wherein the earphone further comprises a battery portion, and the battery portion is connected to another end of the connection portion opposite to the fitting portion;
wherein a side of the fitting portion opposite to the first side portion along the length direction of the fitting portion is defined as a second side portion; within the longitudinal center plane of the fitting portion, the battery portion is located outside an outer periphery of the second side portion of the fitting portion.

14. The earphone according to claim 13, wherein within the longitudinal center plane, a minimum distance between an outer periphery of the battery portion and the outer periphery of the fitting portion along the length direction of the fitting portion is greater than 5 millimeters and less than 9 millimeters.

15. The earphone according to claim 13, wherein within the longitudinal center plane, a central axis of the fitting portion along the length direction of the fitting portion extends through a space enclosed by an outer periphery of the battery portion.

16. The earphone according to claim 15, wherein the fitting portion is configured to resist against an upper ear root of the ear, and the battery portion is configured to resist against a back surface of a helix tail of the ear and/or against a back surface of an earlobe of the ear, when the earphone is worn on the ear.

17. The earphone according to claim 16, wherein within the longitudinal center plane, a resisting vector of the fitting portion points to a portion where the battery portion resists against the ear when the earphone is worn on the ear, the resisting vector is a vector starting from a point where the fitting portion resists against the upper ear root, and a direction of the resisting vector is the length direction of the fitting portion.

18. The earphone according to claim 13, wherein a geometric center of a connection surface where the battery portion is connected to the connection portion, is located on a side of a central axis of the battery portion close to the fitting portion, and the central axis of the battery portion is along a length direction of the battery portion.

19. The earphone according to claim 18, wherein the battery portion comprises a plug hole, the end of the connection portion is connected to the battery portion through the plug hole;
within the longitudinal center plane, a predetermined angle is formed between a central axis of the plug hole along a depth direction of the plug hole and the central axis of the battery portion, a part of the central axis of the plug hole is located outside the battery portion, and the part of the central axis of the plug hole outside the battery portion is located on a side of the central axis of the battery portion close to the fitting portion.

20. The earphone according to claim 19, wherein an angle between the central axis of the plug hole and the central axis of the battery portion is in a range from 25 degrees to 40 degrees.
